(19) United States
(12) Patent Application Publication
(10) Pub. No.: US 2009/0229928 A1
(43) Pub. Date: Sep. 17, 2009

(54) Method and apparatus for constraining a bicycle

(76) Inventor: Kendall A. Kelsen, Scotts Valley, CA (US)

Correspondence Address: MICHAEL A. GUTH, 2-2905 EAST CLIFF DRIVE, SANTA CRUZ, CA, 95062, US

(21) Appl. No.: 12/287,715

(22) Filed: Oct. 10, 2008

Related U.S. Application Data
(63) Continuation-in-part of application No. 12/077,062, filed on Mar. 14, 2008.

(51) Int. Cl. B62L 3/06

(52) U.S. Cl. 188/24.18; 188/265

(57) ABSTRACT

A device and method adapted to keep a bicycle upright and stable while not in use that engages one or more brake levers and the brakes of the bicycle, while the bicycle is leaned against an object. A device and method which is lightweight, easy to keep with the bicycle, and which is adapted to be used with a large variety of types of bicycles. A device and method adapted to keep a bicycle upright and stable while leaned against an object while on a slope.

### REFERENCE TO RELATED APPLICATIONS

This application is a continuation in part of U.S. application Ser. No. 12/077,062 to Kelsen with a filing date of Mar. 14, 2008.

### BACKGROUND

1. Field of the Invention

This invention relates to bicycles, and more specifically to an apparatus and method for braking a bicycle while parked.

2. Description of Related Art

Traditionally, a kickstand has been used to allow a bicycle to stand in an upright position when the bicycle is not in use. A typical kickstand is mounted to a bicycle and is adapted to swing down to contact the ground on which the bicycle rests. Certain bicycles, however, are currently used without kickstands. Such bicycles include, for example, mountain bikes and high-end road bikes. The reasons for excluding kickstands from certain bicycles include reducing the weight of road and mountain bikes and promoting safety in the use of mountain bikes, as kickstands may be hazardous in the off-road conditions over which a mountain bike traverses. Due to the exclusion of a kickstand, such bicycles lack the ability to stand in an upright position when not in use. A bicycle without a kickstand, therefore, often must be propped against a vertical surface, such as a wall or tree, or placed on the ground in order to support the bicycle when not in use. However, propping a bicycle against a vertical surface or placing the bicycle on the ground for storage of the bicycle, or to perform a maintenance activity such as cleaning the bicycle, can be unstable, inconvenient, and unsafe.

Thus, some users have a separate stand at home for use with their bicycle, in order to park it when not in use. An example of such a stand is seen in U.S. Pat. No. 6,976,593 to Fierstein. A distinct limitation of this approach is that a user may also want to park the bicycle when not at home or near the stand.

When a person rides a bicycle that is not equipped with a kickstand and takes a break from riding, the bicycle is often leaned against an object or placed on the ground. Placing the bicycle on the ground is often undesirable as damage can occur. When a bicycle is stood upright against an object the bicycle has a high potential to fall over if not positioned properly or if bumped, especially where the terrain on which the bicycle is stood has a slope. While standing, the wheels can turn, causing the bicycle to roll away from the support upon which it had been leaning.

What is called for is a device and apparatus which allows for stable parking of a bicycle that has not been equipped with a traditional kickstand.

### SUMMARY

A device and method adapted to keep a bicycle upright and stable while not in use that engages one or more brake levers and the brakes of the bicycle, while the bicycle is leaned against an object. A device and method which is lightweight, easy to keep with the bicycle, and which is adapted to be used with a large variety of types of bicycles. A device and method adapted to keep a bicycle upright and stable while leaned against an object while on a slope.

### BRIEF DESCRIPTION OF THE DRAWINGS

FIG. 1 is a perspective view of a parking brake device according to some embodiments of the present invention.

FIG. 2 is a top view of a parking brake device according to some embodiments of the present invention.

FIG. 3 is a view of a parking brake device stowed on the handlebar of a road style bicycle.

FIG. 4 is a view of a parking brake device in use on the handlebar of a road style bicycle.

FIG. 5 is a view of a parking brake device stowed on the handlebar of a mountain bike style bicycle.

FIG. 6 is a view of a parking brake device in use on the handlebar of a mountain bike style bicycle.

FIG. 7 is a view of a bicycle with a parking brake device in use as propped against an object.

FIG. 8 is a perspective view of a parking brake device with tabs according to some embodiments of the present invention.

FIG. 9 is a front view of a parking brake device with tabs according to some embodiments of the present invention.

FIG. 10 is a top view of a parking brake device with tabs according to some embodiments of the present invention.

FIG. 11 is a side view of a parking brake device with tabs according to some embodiments of the present invention.

FIG. 12 is a view of a parking brake device in use on the handlebar of a road style bicycle.

FIG. 13 is a view of a parking brake device in use on the handlebar of a mountain bike style bicycle.

FIG. 14 is a view of a parking brake device on the handlebar of a bicycle.

### DETAILED DESCRIPTION

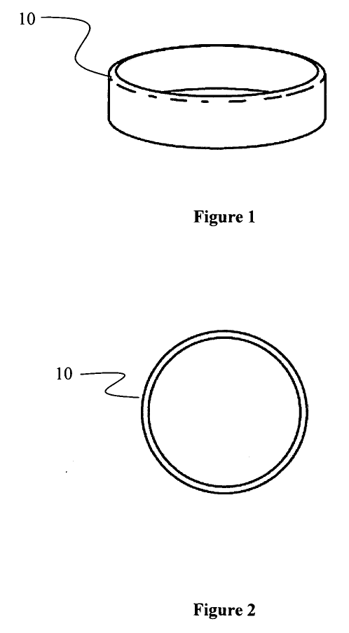

In some embodiments of the present invention, as seen in FIGS. 1 and 2, a parking brake device 10 for a bicycle is seen as an annular band of material. In some embodiments, the material is a relatively stiff elastic material. In some embodiments, the device 10 may have a diameter of approximately 1.1 inches n its relaxed state, with a depth of ⅜ of an inch, and a thickness of 1/16 of an inch. The parking brake device is adapted to reside snugly over the outside diameter of a bicycle handlebar, which is typically just larger than the relaxed diameter of the device. The parking brake device is also adapted to stretch to approximately twice this diameter, in order to allow for the grabbing of a brake lever as described below.

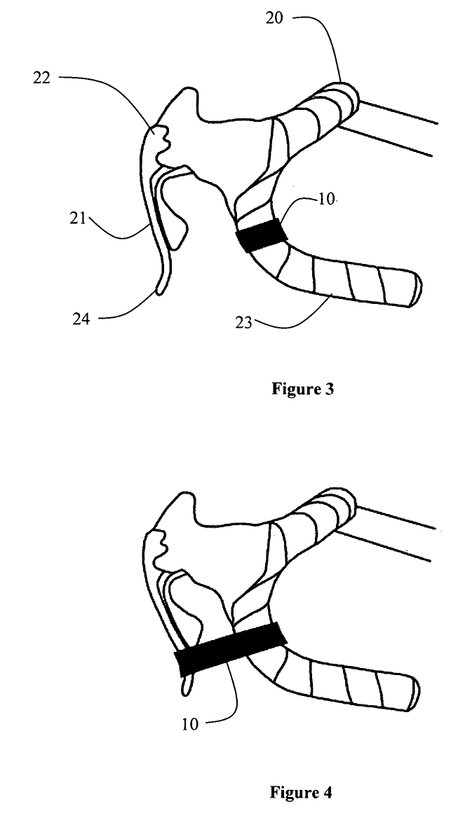

FIGS. 3 and 4 illustrate the use of a parking brake device 10 on the handlebar 20 of an exemplary road bicycle. The handlebar 20 curves to a hand rest area 23 indicative of a road bicycle handlebar. A brake lever 21 typically pivots around a pivot 22 at a first end and may have a slight outgoing curve at a second end 24. The parking brake device 10 is adapted to reside on the handlebar in an unintrusive fashion, ideally not interfering with the normal use of the bicycle while being ridden.

However, once the rider had stopped, and desires to park the bicycle by leaning it upright against an object, the rider runs the distinct risk that the front wheel will begin to roll a bit, perhaps even turning, and then the bicycle rolls away from its upright stance against the object and crashes to the ground. As seen if FIG. 4, the parking brake device 10 is stretched over the brake lever 21, which will engage the brake of the bicycle. A preferred use is on the front brake, as the front tire is the tire most vulnerable to rolling off in practice. Thus, with the use of a device that is provides almost no weight burden to the rider, a safe parking of the bicycle can be managed.

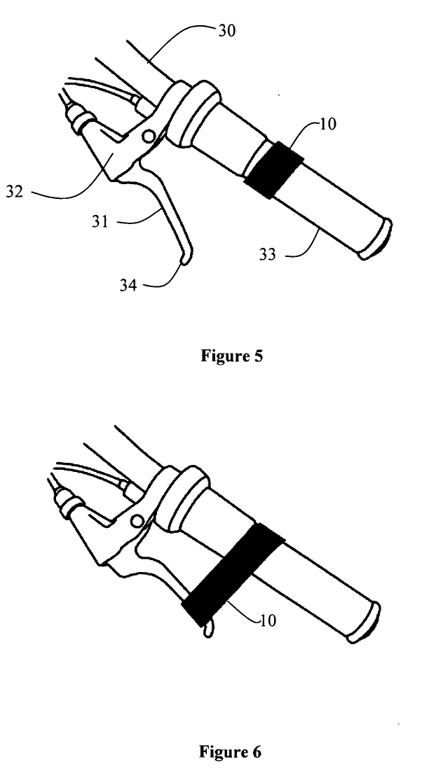

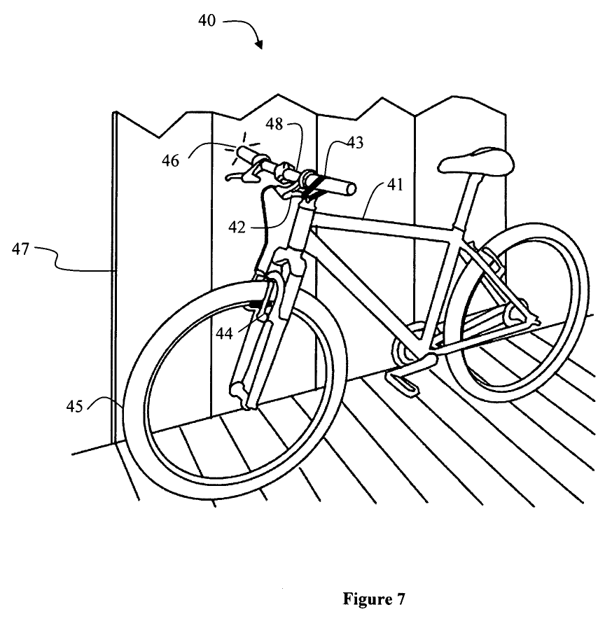

FIGS. 5 and 6 illustrate the use of a parking brake device 10 on the handlebar 30 of an exemplary mountain bike. The handlebar 30 typically goes out straight to a hand rest area 33 indicative of a mountain bike handlebar. A brake lever 31 typically pivots around a pivot 32 at a first end and may have a slight outgoing curve at a second end 34. The parking brake device 10 is adapted to reside on the handlebar in an unintrusive fashion, ideally not interfering with the normal use of the bicycle while being ridden. As seen if FIG. 6, the parking brake device 10 is stretched over the brake lever 31, which will engage the brake of the bicycle.

Although described here in terms of a removable band that resides on the handlebar, in other embodiments the device may be more permanently a part of the handlebar, and may be a solid clip adapted to grab the braked lever in its compressed position. In other embodiments, the device may be of a fastened type wherein a flexible piece, such as cloth or rubber or other soft material, is wrapped around the brake lever and fastened, such as with loop fasteners or other means.

FIG. 7 illustrates a bicycle parking system 40 wherein a bicycle 41 is parked against an object, here a fence 47, utilizing a parking brake device 43. The handlebar 48 of the bicycle has been placed against the fence 47 at a contact point 46. The front brake lever 42 has been compressed by the device 43, which also resides around the handlebar 48. The front brake lever 42 engages the front brake 44, which in turn prevents rotation of the front tire 45. In this constrained condition, the bicycle is prevented from rolling away from the fence 47, and the bicycle may be parked in a relatively secure fashion.

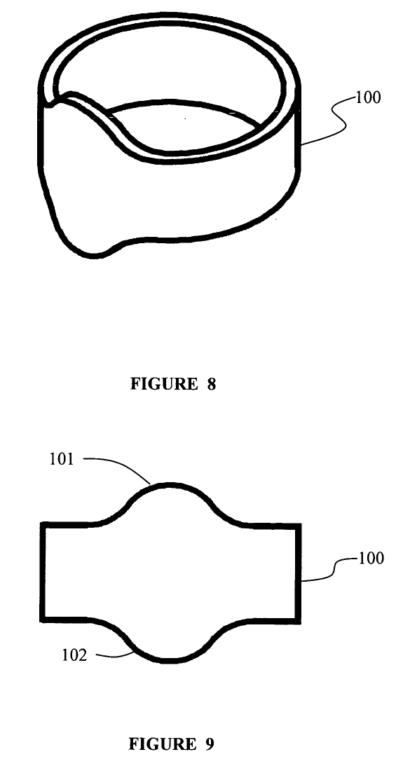

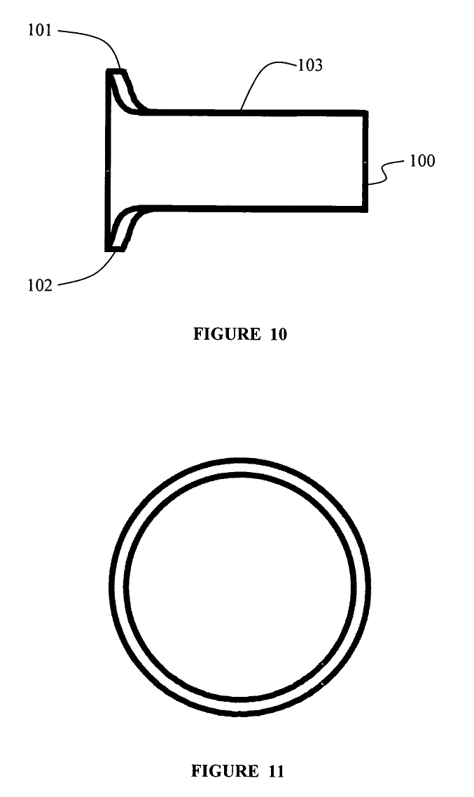

In some embodiments of the present invention, as seen in FIGS. 8, 9, 10, and 11, a parking brake device 100 for a bicycle is seen as an annular band of material with tabs 101, 102 along its edges 103. In some embodiments, the material is a relatively stiff elastic material. In some embodiments, the material is silicone with a durometer reading of 35. In some embodiments, the device 10 may have a diameter of approximately 1.1 inches n its relaxed state, with a depth of ⅜ of an inch, and a thickness of 1/16 of an inch. The parking brake device is adapted to reside snugly over the outside diameter of a bicycle handlebar, which is typically just larger than the relaxed diameter of the device. The parking brake device is also adapted to stretch to approximately twice this diameter, in order to allow for the grabbing of a brake lever as described below.

In some embodiments, the annular band may have a main band portion 103 which may be of substantially the same width. The annular band may also have one or more tabs 101, 102 along the edges of the band. The tabs are adapted to allow the user to more easily grasp the parking brake device when needed to pull the tab from a position where it is simply snugly around the handlebar to a position where it has been stretched to grab the brake lever. It may difficult for the user to grab the annular band when it is residing around the handlebar alone, as the low profile of the band, which is an asset in its unobtrusiveness while on the handlebar, may prove tricky to grab and pull out in some cases, such as when the user's fingers are cold, when the user is wearing gloves, when the band is wet, or in other cases. The tabs, although residing against the handlebar, will not be under the same strain as the portions of the band within its predominant width range. The tabs can thus be rolled up off of the handlebar and provide a portion which can be more easily grabbed to facilitate the pulling of the band over the brake lever. In some embodiments, there may be one tab. In some embodiments, there may be a pair of tabs adjacent to each other on opposite edges of the band. In some embodiments, there may be more tabs.

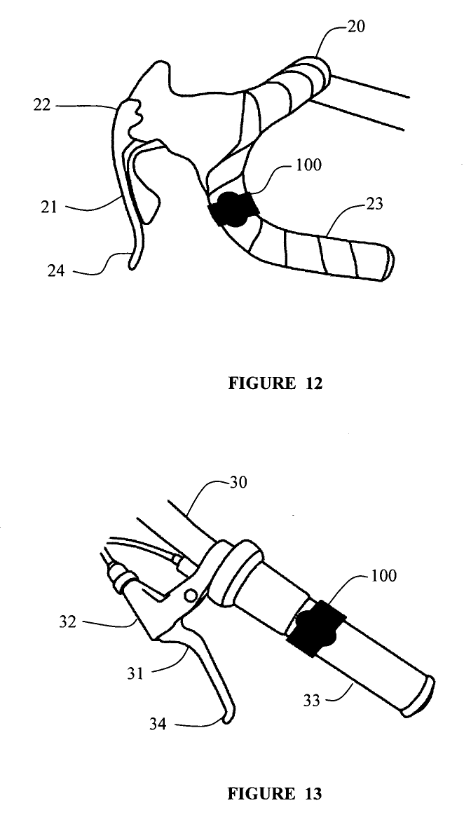

FIG. 12 illustrates the use of a parking brake device 100 on the handlebar 20 of an exemplary road bicycle. The handlebar 20 curves to a hand rest area 23 indicative of a road bicycle handlebar. A brake lever 21 typically pivots around a pivot 22 at a first end and may have a slight outgoing curve at a second end 24. The parking brake device 100 is adapted to reside on the handlebar in an unintrusive fashion, ideally not interfering with the normal use of the bicycle while being ridden.

However, once the rider had stopped, and desires to park the bicycle by leaning it upright against an object, the rider runs the distinct risk that the front wheel will begin to roll a bit, perhaps even turning, and then the bicycle rolls away from its upright stance against the object and crashes to the ground. The parking brake device 10 is adapted to be stretched over the brake lever 21, which will engage the brake of the bicycle. A preferred use is on the front brake, as the front tire is the tire most vulnerable to rolling off in practice. Thus, with the use of a device that is provides almost no weight burden to the rider, a safe parking of the bicycle can be managed.

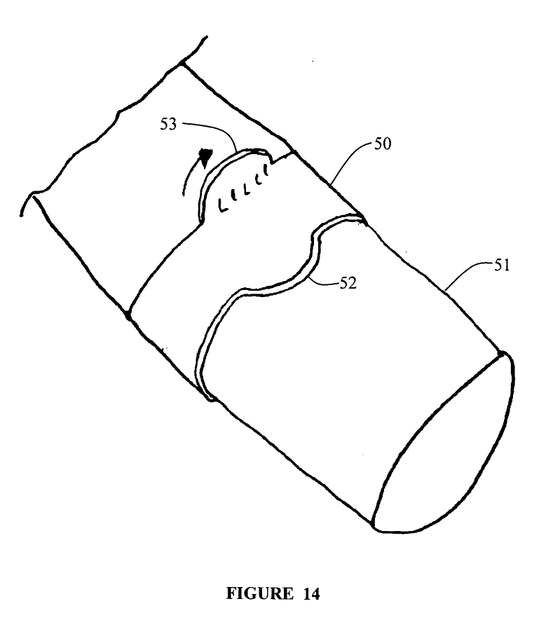

FIG. 13 illustrates the use of a parking brake device 100 on the handlebar 30 of an exemplary mountain bike. The handlebar 30 typically goes out straight to a hand rest area 33 indicative of a mountain bike handlebar. A brake lever 31 typically pivots around a pivot 32 at a first end and may have a slight outgoing curve at a second end 34. The parking brake device 100 is adapted to reside on the handlebar in an unintrusive fashion, ideally not interfering with the normal use of the bicycle while being ridden. The parking brake device 10 is adapted to be stretched over the brake lever 31, which will engage the brake of the bicycle.

FIG. 14 illustrates a bicycle handlebar 51 with a parking brake device 50 with tabs 52, 53 along its edges. As seen, the first tab 53 has been rolled upwards, as would be the case if rolled by the thumb or finger of a user. The tab is able to be somewhat easily rolled into a position which allows for more easy grasping, and subsequent pulling, as the tab along the edge is not subject to the same stresses and strains which may constrain the portion of the annular band within its primary width.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A system for constraining a parked bicycle, said system comprising:
a bicycle, said bicycle comprising:
a handlebar; and
a brake lever attached to said handlebar, said brake lever adapted to engage a brake device when held in a depressed position; and
an elastic band, said elastic band adapted to reside on said handlebar, wherein said elastic band is adapted to capture said brake lever and hold it in a depressed position, said elastic band comprising:
an annular band, said annular band comprising a first tab along a first edge of said annular band.

2. The system of claim 1 wherein said brake lever is adapted to engage a brake device on the front tire of said bicycle.

3. The system of claim 1 wherein said brake lever is pivotally attached to said handlebar.

4. The system of claim 1 wherein said annular band further comprises a second tab along a second edge of said annular band.

5. The device of claim 3 wherein said annular band further comprises a second tab along a second edge of said annular band.

6. A parking brake device adapted for mounting on a bicycle handlebar, said device comprising:
an annular band, said annular band comprising a first tab along a first end of said annular band.

7. The device of claim 6 wherein said annular band further comprises an elastic material.

8. The device of claim 7 wherein said elastic material comprises silicone.

9. The device of claim 6 wherein said annular band further comprises a second tab along a second end of said annular band.

10. The device of claim 8 wherein said annular band further comprises a second tab along a second end of said annular band.

11. An annular band for pulling a brake lever towards a bicycle handlebar, said annular band comprising:
a main band portion, said main band portion comprising a thin annular ring, said thin annular ring having an inside surface and an outside surface, said thin annular ring having a first side edge and a second side edge; and
a first tab, said first tab comprising a tab of material along said first side edge of said thin annular ring.

12. The annular band of claim 11 further comprising a second tab, said second tab comprising a tab of material along a second side edge of said thin annular ring.
